(19) United States
(12) Patent Application Publication
(10) Pub. No.: US 2002/0184453 A1
(43) Pub. Date: Dec. 5, 2002

(54) Data bus system including posted reads and writes

(76) Inventors: Suzanne M. Hughes, Barna (IE); Tadhg Creedon, Furbo (IE); Denise De Paor, Carraroe (IE); Vincent Gavin, Galway (IE); Kevin J. Hyland, Dublin (IE); Kevin Jennings, Ballinasloe (IE); Mike Lardner, Tuam (IE); Derek Coburn, Dundalk (IE)

Correspondence Address: NIXON & VANDERHYE P.C., 1100 North Glebe Rd., 8th Floor, Arlington, VA, 22201-4714, US

(21) Appl. No.: 09/893,658

(22) Filed: Jun. 29, 2001

(30) Foreign Application Priority Data
Jun. 5, 2001 (GB) 0113601.9

(51) Int. Cl. G06F 13/00

(52) U.S. Cl. 711/150

(57) ABSTRACT

A data bus system in which a read or write transaction includes an identification of the initiator of the transaction and optionally an identification of the transaction as a number in a cyclic progression and optionally a request for an acknowledgement. The system allows confirmation that a particular transaction has occurred before a succeeding transaction is enabled to

### CROSS REFERENCE TO RELATED APPLICATIONS

Creedon et al. entitled “ASIC SYSTEM ARCHITECTURE INCLUDING DATA AGGREGATION TECHNIQUE” filed of even date herewith and commonly assigned herewith.

### FIELD OF THE INVENTION

This invention relates to data systems, particularly application specific integrated circuits, which include data buses which are required to convey (particularly in a write operation) data signals from a variety of sources to a selectable target, for example in data memory, and/or to obtain (i.e. in a read operation) data signals for a variety of initiators from a target (particularly data memory). The invention is particularly intended for use in substantially self-contained data handling systems, sometimes called “systems on a chip” wherein substantially all the functional blocks or cores as well as programmed data processors are implemented on a single chip, with the possible exception of at least some of the memory, typically static or random access memory required to cope with the operational demands of the system.

### BACKGROUND TO THE INVENTION

It is now customary to lay out data systems of this nature with the aid of a program tool, such as paramaterisable verilog. It is generally found that layout is made generally easier and quicker if certain presumptions are made concerning the basic architecture of the system. One such assumption is that operational blocks or cores, which in general operate at different clock rates, communicate with each other only by way of the shared memory. However, the countervailing difficulty is that at least some sections of the bus system must carry heavy and possibly conflicting traffic.

In these and other generally similar systems, it is often desirable for there to be an indication that a particular write operation has occurred before a succeeding task is enabled. One possible technique for dealing with this is to “freeze” bus paths to memory but that degrades the potential performance of the system. Another aspect of a bus system of this nature is that when targets have different latencies, read operations may take different durations to complete and if the data which is retrieved in a set of read transactions must be put in a particular order, an initiator needs to keep a record of the order of both transmission and reception of read requests and replies in order to reassemble the obtained data in appropriate sequence.

### SUMMARY OF THE INVENTION

This invention is based on the concept of “posted” read or write transactions. It is preferably implemented such that, on the data bus, a write request is sent to a target along with source and transaction identifiers. It may also be sent with an option to request an acknowledgement that the data has reached the target. Such a request may be asserted for each section in a series of transactions, for example each data packet in a burst of data packets, or for just the last section, for example the last packet in a burst. The transaction is acknowledged by a return of the source and transaction identifiers on a bus line dedicated to the purpose.

In respect of read transactions, source and transaction identifiers may be sent from an initiator to a target along with the read request. The source identifier may be used to decode which path the read transaction should take when the data is returned from the target to the initiator. The transaction identifier may be used to indicate the number of requests which have been sent and also the number which have been fulfilled. When, for example, requested read transactions are returned to an initiator they may be received out of order owing to the different latencies associated with different bus paths and different cores. It should be appreciated that a read request may be directed to memory but may be required to be conveyed further to a core before it is fulfilled. The return of a transaction identifier enables an initiator to track the requests received and also those which are pending and not yet fulfilled. When all outstanding read requests are returned with their specific transaction identifiers they can then be reordered to be received correctly. Because the transaction identifier for a request is part of the request and is returned with the requests result the initiator is allowed to carry out subsequent requests before the result for the previous requests are returned. The initiator will know that results must come in order and can be reordered by their transactions. If no transaction identifiers were used then it would be impossible to know the order of the returning results. The initiator could only issue subsequent requests when the result for a previous request was returned, thus slowing down the system.

Further objects and features of the invention will be apparent from the following detailed description with reference to the accompanying drawings.

### BRIEF DESCRIPTION OF THE DRAWINGS

FIG. 1 is a schematic diagram of a bus system

FIG. 2 is a schematic diagram of an arbiter in respect of an upward path therein

FIG. 3 is a schematic diagram of an arbiter in respect of a downward path therein

FIG. 4 is a schematic diagram of a register bus bridge

FIG. 5 is a schematic diagram of a “core” or operational block adapted for use in the invention

FIG. 6 is an example of a system on a chip employing the architecture and memory system according to the invention

FIG. 7 is a wave form diagram illustrating a normal write cycle

FIG. 8 is a diagram illustrating a write cycle with a strobe signal

FIG. 9 illustrates write acknowledge timing

FIG. 10 illustrates a write in abnormal circumstances

FIG. 11 illustrates an interrupted write

FIG. 12 illustrates a read command cycle

FIG. 13 illustrates an extended read command cycle.

FIG. 14 illustrates a read cycle

FIG. 15 illustrates a read cycle with a sample signal

FIG. 16 illustrates a paused read cycle

FIG. 17 illustrates a register bus write cycle

FIG. 18 illustrates a register bus read cycle

### DETAILED DESCRIPTION OF A PREFERRED EMBODIMENT

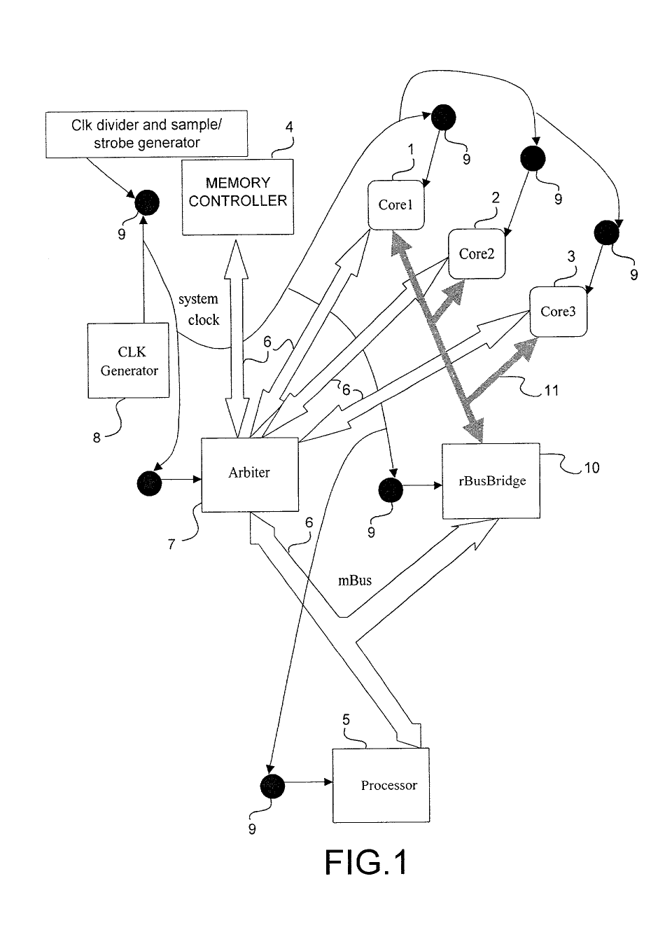

FIG. 1 is a schematic diagram showing basic elements which support a data bus system according to the invention. In the example shown in FIG. 1 there are three “cores”, 1, 2 and 3, which contend for access to a memory (not shown) under the control of a memory controller 4. The cores are connected to the memory by way of a memory bus 6, which is shown as extending between the cores and the memory controller by way of an arbiter 7. It is assumed in this example that the memory controller 4 has only one memory bus interface in the sense towards the memory controller and accordingly the cores as well as a processor 5, as is more fully described and claimed in co-pending application of Creedon et al entitled “ASIC SYSTEM ARCHITECTURE INCLUDING DATA AGGREGATION TECHNIQUE” filed on the same day as the present application.

The memory bus, denoted herein as “mBus”, constitutes the mechanism for the processor 5 and/or the cores 1, 2 and 3 to read from and write to locations in the memory. Thus “mBus” as used herein signifies a direct memory bus to and from the memory.

The memory bus has a multiplicity of lines, as well as associated lines, which are described herein. The physical implementation will not be described because the scheme of the present invention is intended to be independent of the particular physical realisation.

The memory bus (mBus) is implemented as a “half-duplex” bus so that the same signals are used for both read and write transactions. However, full duplex operation is feasible as described later.

Also shown in FIG. 1 is a clock generator 8 which provides a system clock to a multiplicity of “clock divider and sample/strobe generators” 9 which will normally perform clock division, to derive sub-multiples of the system clock. Preferably but not essentially these generators 9 are organized as described in co-pending application for Pratt et al entitled “CLOCK SYSTEM FOR ASIC” filed Jun. 13, 2001. That application describes a clock system wherein derived clocks have a particular relationship with a system clock. As is described in Pratt etal, the particular clock system or complex is organised so that the sub-multiple clocks must occur on defined edges or transitions of the system clock and different transitions are employed for clocking data into a block or core and for clocking data out of a block or core. The main purpose is to render unnecessary synchronisers of “elastic” buffers. Clock dividers provide sample and strobe clocks as described in the aforementioned application in order to restrict the clocking of data to selected ones of the various possible transitions. This is particularly important where data is transferred between different clock domains. These clocks and also logic clocks for controlling logic within cores, are full described in the aforementioned application of Pratt et al.

Elements of mBus

The bus may physically be implemented in known manner to have the address/data lines and other select and control lines which carry the signals described below.

“mBusWrData” denotes a multiple-bit multiplexed data/address bus. During the first phase of a transaction the address is placed on the bus and during the second and subsequent phases data is placed on the bus. The bus may be 32 bits wide but any other reasonable width may be employed.

“mBusWrSel” denotes a select signal (or the corresponding line) which is used to select the target of the transaction. In the example shown in FIG. 1 there would be two “select lines” from the processor 5, one to select the arbiter 7 as a target and the other to select the rBusBridge. The Arbiter has one select line to select the Memory Controller and the cores have one select line each to select the arbiter as their targets.

“mBusWrInfo” denotes a signal which gives information on the transaction in progress. It contains the source and transaction identifiers during the address phase and contains “byte valids” during the data phase. On the last phase of the transaction, as well as containing the byte valids it also contains a request to acknowledge the transaction.

“mBusWrAck” is the corresponding acknowledgement, for the transaction that requested an acknowledgement on completion.

The control signals (on corresponding lines) for the bus are as follows

(I) “mBusWrPhase” is a two-bit signal which can have four values, denoting start of frame (SOF), normal transmission (NORMAL), idle (IDLE) and end of frame (EOF)

(II) “mBusWrRdy” is a single bit which if set indicates that the target is ready to accept a new transaction

(III) “mBusWrBrstRdy” indicates that the target is ready to accept a burst

(IV) “mBusWrEn” is an enabling signal which indicates that a transaction is either a read or a write

rBus

Also in the example shown in FIG. 1 the processor 5 tries to gain access to the cores via another bus, a register bus 11 denoted herein as “rBus”. The rBus 11 is somewhat different to and simpler than the mBus. The processor 5 uses the rBus 11 to read from and write to registers in the cores. The registers which determine or indicate, for example, the operational mode of a core can be accessed only through rBus. In this example the processor has only a mBus interface so a bridge 10 is used to translate mBus signals into rBus signals and vice-versa.

Elements of rBus

rBus is preferably implemented as a half duplex bus, and is therefore a simple bus that can only deal with one transfer at any one time to only one core. Bursts are not supported on such an rBus i.e. multiple registers cannot be accessed in one transaction.

“rBusWrData” denotes data to be written to the target register.

“rBusAddr” denotes the address of the target register to read from or write to.

“rBusSel” denotes a select signal. The bridge needs to select the core with which it wants to communicate. There is a separate select line generated by the rBusBridge to target each core.

“rBusWrValid” is a signal used for writes only to distinguish which bytes of the data bus are valid.

“rBusRdEn” denotes a signal which indicates if the transaction is a read from a register or a write.

“rBusRdy” is a signal from each core returning to the rBusBridge, indicating the last transaction is complete and the core is ready to deal with the next one.

“rBusRdData” denotes read data on a separate bus from each core returning the data read from a particular register location to the rBusBridge.

Arbiter

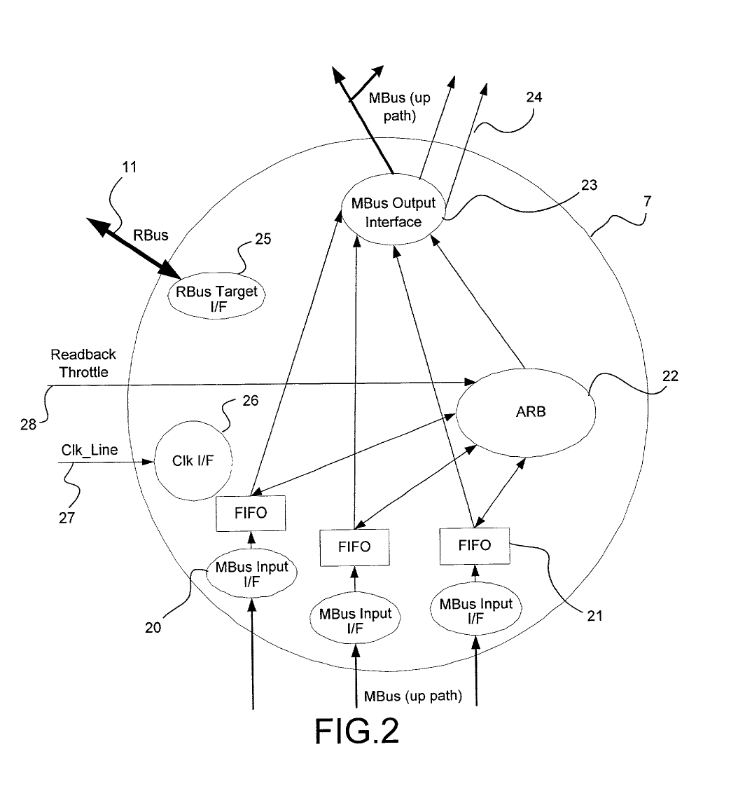

The arbiter 7 in FIG. 1 is preferably in two parts, called herein the “upward path” and the “downward path”. FIG. 2 illustrate the upward path, i.e. the direction in which data passes from a core or the process to the memory controller 4. The arbiter includes an “mBus Input Interface” 20 for each initiator (i.e. each core or processor connected by a section of the bus 6 to the arbiter 7). This interface block 20 clocks input (write) data into the arbiter on a negative edge of the arbiter's clock. The clock interface is shown schematically at 26.

The arbiter contains one FIFO 21 for each initiator. Each FIFO 21 is coupled to a respective interface 20 and the write or read Request data is stored in the FIFO while waiting to be granted access to the arbiter's output port. Each FIFO may be of selectable depth and needs a width at least equal to the sum of the widths (i.e. number of bits) of (mBusData+mBusPhase+mBusWrInfo+mBusRdEn). In a typical example these widths are (32+2+16+1)=51 bits.

A block 22 denoted “Arb” performs the arbitration algorithm. The particular algorithm is not important. It may for example employ TDMA (time-division multiple access) giving high priority to some initiators and low priority to others. The Arb block 22 will also decode the destination address and assert a corresponding select line.

The arbiter contains a single “mBus Output Interface” 23 which is coupled to the up path of the mBus 6 and select lines 24. It contains a multiplexer to choose the correct output data, which is controlled by the Arb 22. It also clocks out data on the positive edge of the clock controlling the arbiter.

The “rBusTarget Interface” 25 is coupled to the rBus 11 and contains registers for the arbiter. They may contain or define priorities and slots for the arbiter's algorithms and can be written over the rBus. The registers contain threshold values for FIFOs, to tell FIFO when to request arbitration, and when to de-assert mBusWrRdy.

FIG. 2 also shows a clock interface 26 coupled to a clock line 27. The readback throttle 28 is a signal which indicates that a readback FIFO is full and is unable to receive any more requests.

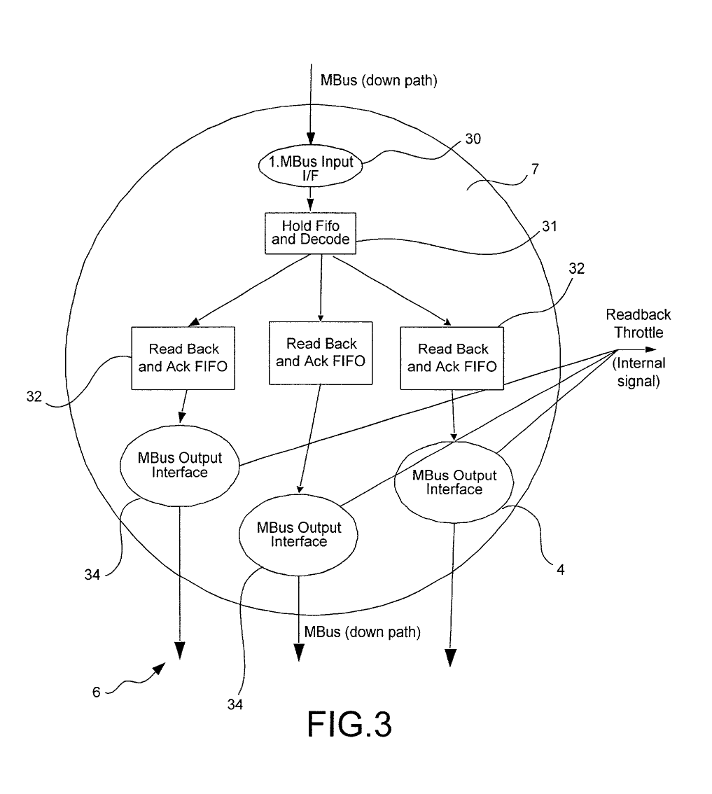

The “downward path” of the arbiter 7 is shown in FIG. 3. There is an “mBus Input Interface” 30 for each possible target (only one being shown in FIG. 3). This block clocks input (read) data into the arbiter on a negative edge of the arbiter clock.

There is a “Hold Fifo and Decode” block 31 for each target, coupled to the respective interface 30. Read data is stored here temporarily, while decoding is performed. The returning source ID is decoded, and the read data is sent to the Rd FIFO corresponding to the correct initiator.

There is a Read back and Acknowledge FIFO 32 for each initiator. The read data is stored in a FIFO while waiting for access to the arbiter's read back output port represented by interface 34. Each FIFO 32 is parameterisably deep and has a width equal to (mBusData width+mBusPhase width+mBusRdValid width). The write acknowledgement may be stored independently in a separate FIFO, which is parameterisably deep, and 8 bits wide.

The downward path includes an “mBus Output Interface” 34 for each initiator. Each interface clocks out the read data on a positive edge of the arbiter's clock.

rBusBridge

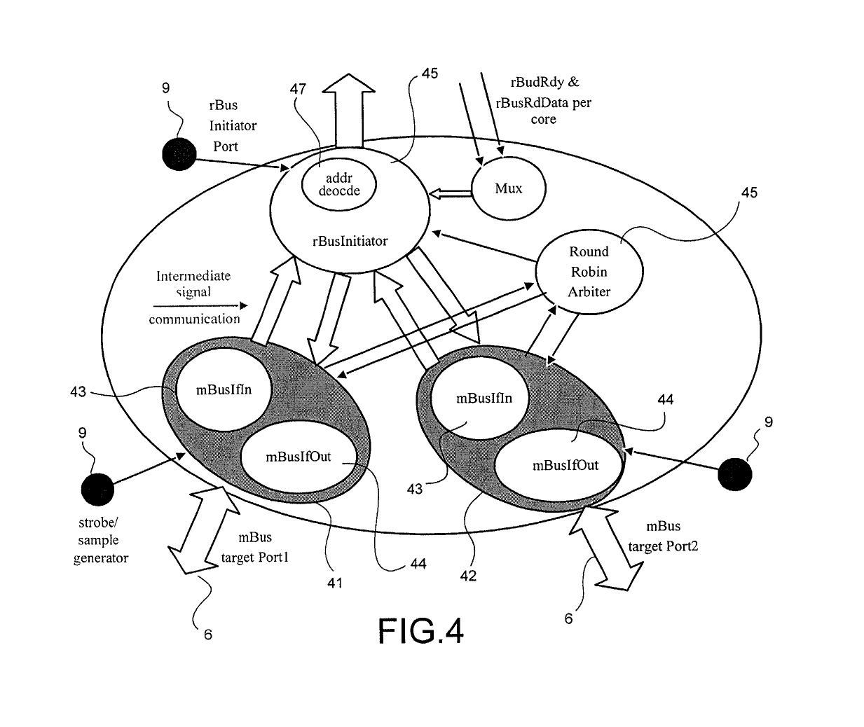

FIG. 4 illustrates schematically an rBusBridge 10. It is associated with various strobe and sample clock generators 9 each of which derives from the system clock appropriate divided-down clocks for the relevant block within the bridge 10. Operational blocks 41 and 42 within bridge 10 each include a memory bus input module (mBusIfIn) 43 and a memory bus output module (mBusIfOut) 44 coupled to the relevant segment of the memory bus 6 to the relevant target. For each mBusIfIn 43 all signals are clocked into the mBusIfIn module on the positive edge of the appropriate divided down system clock when a sample clock is high. All signals are clocked out of this module using the negative edge of the divided down clock when the strobe clock is high. Only one request at a time can be processed. The address, data and valids are stored in a register until they are granted access to an rBus Initiator 45 mBusIfIn 43 deals with both read and write requests, it also generates an acknowledge upon request. There is one of these modules per input port on the mBus side.

The mBusIfOut module 44 clocks signals in the same manner as mBusIfIn. This module is used to send the register data back to the initiator, with the appropriate control signals on mBus. There is one of these modules per input port on the mBus side.

The bridge 10 includes a Round Robin Arbiter 46. Requests are generated by each mBusIfIn module 43 to arbitrate for access to the rBusInitiator. The requests are dealt with in a round-robin fashion. If “Port1” is granted first then “Port2” will be granted next unless it has no request and so on. Each request is held active until it is granted. An indication of which request is currently granted is sent to the rBusInitiator 45.

The rBusInitiator 45 generates an rBus request based on which port was granted access and the information given with that request. Once a request is sent out on the rBus, the initiator 45 waits until the transaction has finished before starting another request.

Within initiator 45 is an Address Decode block 47. An address decode is performed on the upper bits of the address bus to determine which core the request is destined for. A select is generated for the correct core based on this address. The upper bits of the address bus to be decoded are chosen based on two parameters. The parameters are a start address offset and an end address offset. The value of the parameters depends on the number of core targets and their required memory allocation. For example if four targets are allocated 2k of memory each, the address decode is done on bits [12 11]. The start address decode parameter in this instance is 11 and the end address decode parameter is 12.

When a ready signal or data is returned from a core it is received by a multiplexer (Mux) 48 and, according to the core that was selected, sent back to the rBusInitiator and then on to the mBus via the respective mBuIfOut module.

Elements of a Core

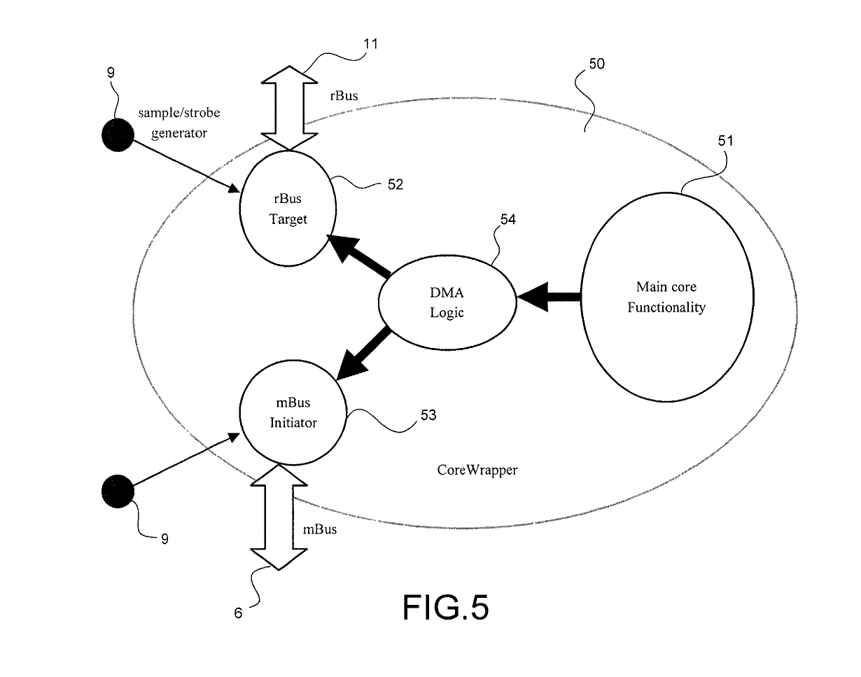

FIG. 5 illustrates the relevant elements of a core 50, corresponding to any of the cores 1, 2 or 3 in FIG. 1. The particular main functionality of the core, represented by block 51, is not important to the invention, which is concerned with the transfer of data between cores, processors etc and memory. Some examples of cores will be described later.

In FIG. 5, the core 50 is shown as coupled to a segment of the memory bus (mBus) 6 and a segment of the register bus 11.

The “rBus Target” block 52 contains registers associated with the core and also provides access to registers within the main core itself. It pulses rBusRdy on completion of a write/read. It also sends back the read data on the rBus at the same time as rBusRdy is pulsed during a read transaction. A fixed address decode in the rBusTarget allows the correct registers to be accessed.

The “mBus Initiator” block 53 converts from a full duplex core to a half/full-duplex mBus. It takes separate address & data buses, and multiplexes them onto one data bus, using a 2-bit phase signal to indicate Start of Frame (where the address is on the data bus). Data Phase with Incrementing/non-incrementing address. End-Of-Frame, or Idle/Stall. It also round robin arbitrates between read and write requests from the core, using the ready signals from the mbus target to identify which request to allow onto the mbus next. It uses a handshaking scheme to inform the core when the core may change its data/request, i.e. when the information is safely transmitted onto the mBus. It pipelines data through the interface in both directions, and has re-timing blocks (where necessary) that obey the number based clocking scheme. It includes select lines corresponding to the number of targets to which it is connected.

The DMA (direct memory access) Logic 54 monitors DMA interrupts from the core, and buffers data to the required amount to be sent on the mBus. It sends data to the mBus initiator when buffers are full or a timeout is reached. It buffers data received from mBus and sends that data to core at the correct speed. The core may run either faster or slower than mBus.

The main core 51 may be a module that is designed in-house or IP acquired from another source. In many instances the core may have a different system bus than that being used on the system. Therefore the core will need to be “wrapped” by means of the rBusTarget 52 and mBusInitiator 53, to enable it to communicate with other devices on the system bus.

The main core 51 will contain state machines, fifo's or buffers, clocking schemes and complex algorithms to carry out its required functionality.

Specific examples or a core and wrappers are described in Creedon et al.

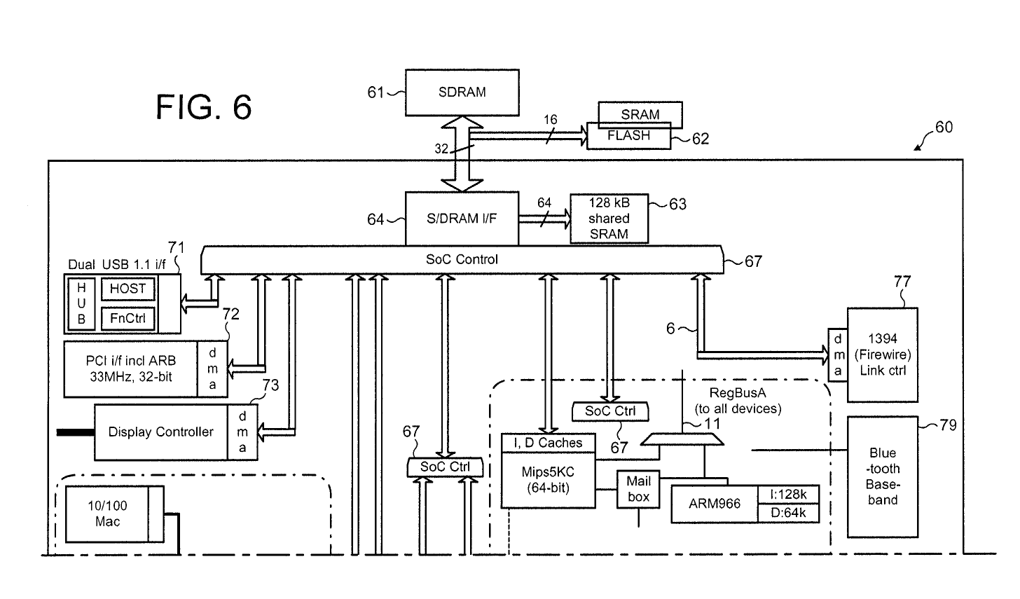

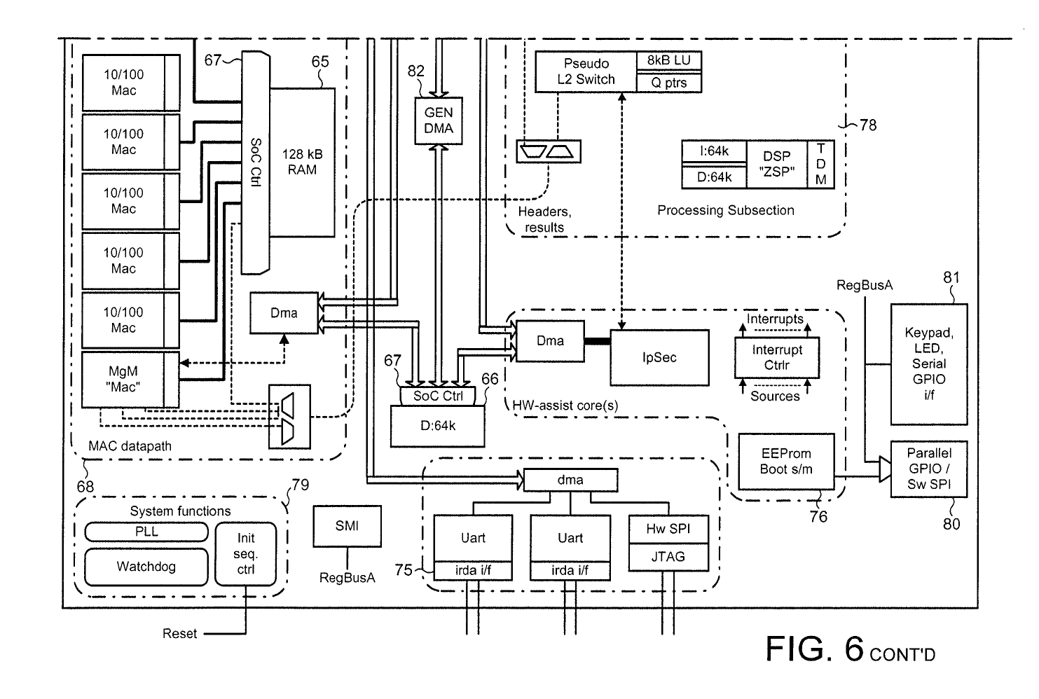

FIG. 6 of the drawings illustrates by way of example only a system on-a-chip 60 intended to implement (in a manner not relevant to the present invention) the various functions (reception, look-up, bridging, routing etc) and the ancillary functions (display, control etc) of a high performance network switch intended for use in a packet-based network which may for example operate according to a suitable Ethernet protocol.

Located external to the chip 60 is synchronous dynamic random access memory (SDRAM) 61, static random access memory 62. On-chip memory is provided by 128 kilo bit shared static random access memory 63. Memory 61, 62 and 63 are written in to and read from under the control of an interface 64. Further on-chip memory is provided by a random access memory 65 and a comparatively small dynamic memory 66 as will be seen from later description.

Interposed between the various memories and the memory bus segment 6 which coupled the memory to the various cores or operational blocks in the system are control blocks 67 which are intended to perform the arbiter functions previously described. There is a control 67 for the interface 64 and other such controls for random access memory 65, memory 66 and so on.

The chip includes a variety of individual cores connected so that they can communicate with each other, if at all, only by way of memory. Examples of these are a dual USB interface 71, a PCF interface 72 and a display controller 73. A media access control (MAC) data path 68 includes a multiplicity of cores. 10/100 megabit MAC devices 74, which form a sub-system including a memory controller 68 with memory 65. Low bandwidth DMA cores 75, hardware assist cores 76 and a firewire link control 77 all communicate with the bus by way of direct memory access interfaces, as do cores 71, 72 and 73 as well as the MAC data path 68. A processing sub-section 78 is connected by way of bus segment 6 to the interface 64 but, as indicated previously, also communicates by way of a register bus 11 with all the other devices on the chip. It should be understood that the register bus is employed essentially for sending control status and command signals and suchlike to the various devices whereas the bus 6 is employed for storing “user” or packet data.

Processor sub-section 78 controls a “Bluetooth” base band circuit 79. The hardware assist cores control a general purpose in/out interface 80. The register bus extends to a key pad interface 81.

Item 82 is a generic DMA controller for providing memory-to-memory copies.

Memory Bus Reading and Writing Technique

The foregoing is intended to provide an appreciation of the architectural framework in which the memory bus writing and reading technique according to the invention may be employed. The description of that technique follows.

The following description concerns the signals on the mBus, and gives a detailed explanation of how to interface to them to or from a core or core wrapper. Through out the following description the data and address signals are 32-bits wide, but in fact these bus widths may be changed to preference.

A description of the rBus signals is also included. On the rBus the data and address signals are also assumed to be 32-bits wide for the purpose of explanation.

In the following description

(I) “Node” indicates a core, an arbiter, a register bridge or a memory device

(II) “Initiator” means a node that starts a read or write transaction

(III) “Target” means a node that is the next stage destination of a read or write. There are both data and register initiator and targets. An example of a data initiator is a core (e.g. UART) or processor. A data target is normally memory. A register initiator is normally a processor and a register target may be a core or memory.

(IV) “HD” means half-duplex mode. In half duplex mode some of the write signals are used to transfer read commands as well as writes.

(V) “FD” means full duplex mode.

(VI) “Incrementing” is used in relation to the address of a transaction. An incrementing address is used for burst writes. A burst write from a core to memory may specify the address as incrementing. This means that the first word is written to the address location specified and subsequent words are written to that address location+N, where N is an integral multiple of an incrementing value. Thus if that value is 4, N may take the values 4, 8, 12, 16 etc.

(VII) “Non-incrementing” means in relating to addressing, that each word in the write is written to a different address, with no regular relationship between the addresses.

(VIII) “Source Id” denotes a unique number assigned to each core, or data source.

(IX) “Transaction Id” refers to a number such that each transaction performed by a core or source is given a transaction ID so it can be easily identified. That is not compulsory however.

Data Path Signals (mBus)

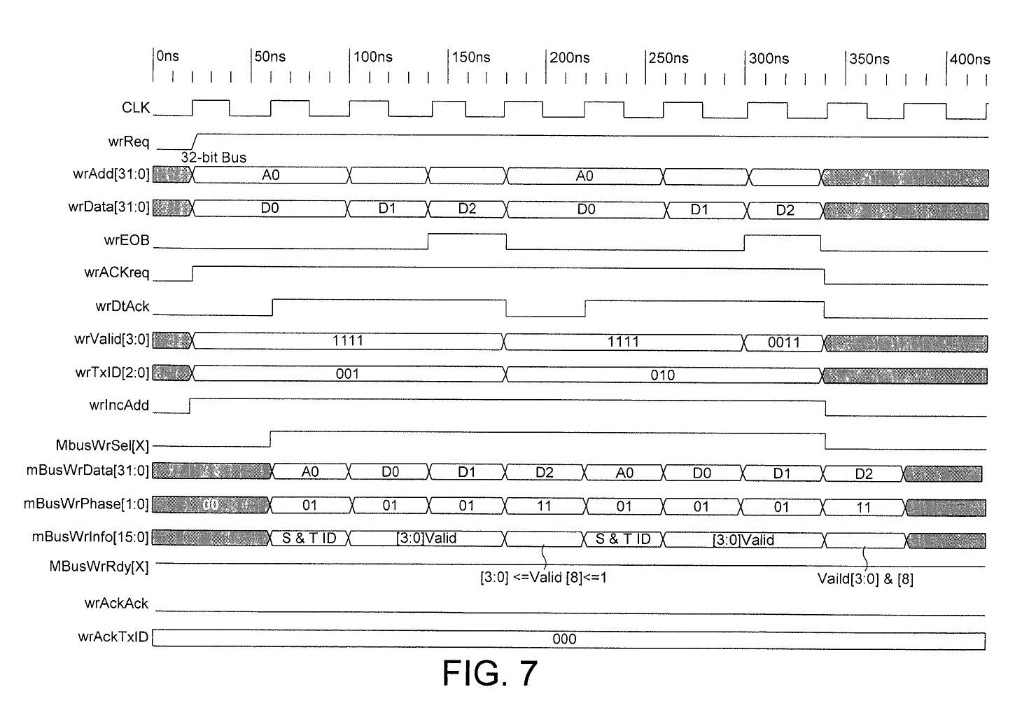

There follows a description of the various signals, some of which are optional, that are or may be applied to respective lines or groups of lines of the bus. In this description, the name of the signal is followed by an indication of it preferred with (in bits), the operational direction and the purpose or significance of the signal. Examples of the occurrences of the signals will be given in FIGS. 7 onwards.

mBusRdEn (1 bit) goes from initiator to target. It is not required in FD, in HD, if full duplex is not required 1=READ and 0=WRITE.

msBusWrRdy (x bits) goes from target to initiator and indicates that space available in the target to write data. Each bit denotes a particular target, so x=number of targets.

msBusWrPhase (2 bits) goes from initiator to target. The value “00” denotes IDLE or Null when mBusWrRdy is deasserted “01” denotes data with incrementing address “10” denoted data with non-incrementing address “11” denotes EOF (on last data word).

mBusWrData (2 bits) goes from initiator to target and indicates that there is address/data to be written into the target.

mBusWrInfo (9 bits) goes from initiator to target and comprises a six-bit source ID field [5 0], and a three-bit transaction ID [2 0] during address phase. If mBusWrPhase [1 0]=11 and an acknowledgement is required, mBusWrInfo[8] is set to 1.

The source identifier (source ID field) has sufficient bits so that all the cores can be uniquely represented. A respective source ID can be “hard coded” into each core wrapper. A transaction ID need not be used by all cores, but are provided where reordering of transactions (particularly read requests) may be required. Transaction identifiers are provided by core wrappers. Typically the first read requests made by a core would have a transaction identifier “b000. Subsequent requests would increment by unity and the transaction identifier would after “b111 (binary 7) wrap around to “b000 (binary zero), so that the transaction identifier represents read requests in cyclic progression.

At the end of a transaction one may check if an acknowledgement for that transaction is required and if so, this is signalled by setting the MSB of mBusWrInfo. MBusWrInfo [3 0] are the burst valid bits during data phase.

mBusWrAck (9 bits) goes from target to initiator and is an acknowledgment that data (full burst) has been written to final destination. The values of the source and transaction ID for the transaction being acknowledged are present on the bus for one clock tick.

mBusWrSel[X 0] goes from initiator to target. X equals the number of targets. The source node decodes the destination of the write and selects the correct target node. There is no decode if there is only one target.

mBusRdCmdRdy [X 0] goes from target to initiator and indicates whether there is space available in target to write the mBusRdCmd.

mBusRdCmdPhase goes from initiator to target. When it is “00” it signifies IDLE or Null.

When mBusRdCmdRdy is deasserted “01] signifies address phase with incrementing address “10” signifies address phase with non-incrementing address “11” signifies EOF. It corresponds to mBusWrPhase in HD.

mBusRdCmdData (32 bits) goes from initiator to target and denotes the read address or burst length [6 0], the source ID [5 0] and the transaction ID [2 0]. It corresponds to mBusWrData in HD.

mBusRdCmdSel (X 0) goes from initiator to target. It corresponds in FD to mBusWrSelX in HD.

mbusRdData (32 bits) goes from target to initiator and denotes the data read from target.

mbusRdDataPhase (32 bits) goes from target to initiator “00” denotes IDLE or NULL when mBusRdDataRdy deasserted, “01” denotes SOF (contains source ID and transaction ID), “10” denoted data; “11” denotes EOF.

mBusRdDataRdy (X 0) goes from initiator to target. X equals number of read data buffers in initiator. In each arbiter/core there is a buffer on the input path to store the data. If the buffer becomes full we need to prevent any more data being written into it as this would cause data to be over written and lost. The mBusRdDataRdy signal is deasserted when the buffer is full and asserted again when the buffer has emptied and is ready to accept new data.

mBusRdDataSel (X 0) goes from target to initiator. X equals the number of read data buffers in the initiator.

Register Path Signals (rBus)

rBusRdy (X bits) goes from target to initiator. It signifies that the core has received and processed the data and is ready to accept new data. X equals the number of targets.

rBusWrData (32 bits) goes from initiator to target and comprises the data to be written to the target.

rBusWrAddr (32 bits) goes from initiator to target and is the address to which data is to be written. This is also used to request a read from the location specified by this address, during a read transaction.

rBusSel (X bits) goes from initiator to target. There is one for every target node connected. The signal selects the correct target. X equals the number of targets (cores).

rbusWrValid (4 bits) goes from initiator to target. They are byte enable signals.

rBusEdEn (1 bit) goes from initiator to target. It is not required in FD. In HD if full duplex is not required 1=READ and 0=WRITE.

rBusRdData (32 bits) goes from target to initiator. It is data read by the initiator. One from each target (muxed before initiator).

Mbus Interface Timing

Signals coming from the core wrappers will need to be translated into mBus signals so they are suitable for transmission around the ASIC. This task will be performed by the mBus interface. The timing diagrams in the following examples are for a 32-bit address and a 32-bit data bus on the core side, and a 32-bit mixed address and data bus on the mBus side. The signals on the mBus side of the interface are detailed in the Data Path Signals section above. The signals on the core side of the interface are detailed below.

The interface is parameterizable, as follows. SOURCE_ID[5 0] should be a unique number to identify the source. TARGET_TOTAL[7 0] is the total number of targets connected to the interface. RD_LEN_BUS_WIDTH is the width of the rdLen signal (see section 12) BUS_BRST_SIZE[RD_LEN_BUS_WIDTH-1 0] is the maximum burst size of which the system is capable of.

These examples show the select and rdy signals as one bit signals, showing only the bit that corresponds to the target being accessed. In reality, these signals are [TARGET_TOTAL 0] wide. The mBusDecode signal from the core is used to give the interface the start and end address of each target in the core's memory map. Only the upper 16 bits of the address space are given. The interface uses this information to perform the address decoding, and to generate separate. Selects for each target. No address decoding is necessary if the core goes to only one target. For the sake of simplicity most of these diagrams do not show the “strobe” or “hold” signals required for crossing clock domains as described in the co-pending application of Pratt et al.

Core Wrapper Signals

wrData (32 bits) goes from wrapper to interface and is data to be written.

wrAdd (32 bits) goes from wrapper to interface and is the address to which the data should be written.

wrValid (4 bits) goes from wrapper to interface and is the byte valid field.

wrTxID (3 bits) goes from wrapper to interface and is the transaction ID for the current transaction.

wrReq (1 bit) goes from wrapper to interface and denotes a write request.

wrEOB (1 bit) goes from wrapper to interface and is an end of burst flag.

wrDtAck (1 bit) goes from interface to wrapper and is acknowledge means that write data has been received into interface.

wrIncAdd (1 bit) goes from wrapper to interface. It will drive “high” (1) for incrementing address and “low”(0) for a non-incrementing address.

wrAckReq (1 bit) goes from wrapper to interface. It will be driven high at the same time as wrEOB if an Ack is required.

wrAckAck (1 bit) goes from interface to wrapper and acknowledges a “write”.

wrAckTxID (3 bits) goes from interface to wrapper and is Transaction ID of acknowledged write.

mbusDecode (32 number of targets) goes from wrapper to interface and contains the start and end memory address for each target. Only the upper 16 bits of each address are given. For example, if there are three targets, then mBusDecode is 96 bits wide, target one has addresses from mBusDecode[15 0], to [31 16], target two from [47 32] to [63 47], and target three has any other address outside these parameters.

BurstStartEn (1 bit) goes from wrapper to interface. When it is 1 it denotes burst continue. When it is 0 it denotes burst stalled.

rdReq (1 bit) goes from wrapper to interface and is a read request.

rdAdd (32 bits) goes from wrapper to interface and is the address from which data is to be read.

rdLen (selectable) goes from wrapper to interface and denotes the length in bytes of data to be read. This is parameterisable, as each core may be capable of different maximum size reads RD_LEN_BUS_WIDTH [6 0] defines the size of rdLen.

rdIncAdd (1 bit) goes from wrapper to interface. It is driven high from incrementing address and low for a non-incrementing address.

rdTxId (3 bits) goes from interface to wrapper and is the transaction ID of incoming data read.

rdAck (1 bit) goes from wrapper to interface and is an acknowledge that read command data has been received into the interface.

rdData (31 bits) goes from interface to wrapper and is data to be read.

rdReqTxId (3 bits) goes from wrapper to interface and is the transaction ID or current read request.

rdRdy (1 bit) goes from wrapper to interface and is a “read ready” signal from core wrapper.

rdEOB (1 bit) goes from interface to wrapper and is an end of burst flag.

rdDataSel (1 bit) goes from interface to wrapper and is a read data select flag. This indicates that there is incoming read data.

Normal Write Cycle

FIG. 7 illustrates a typical mBus Write cycle. A0, A1 etc denote successive (32 bit) segments of the address and D0, D1 etc successive (32 bit) segments of the data. To begin a write transaction, wrReq is asserted. MBusWrRdy[X] must also be asserted at this time. In the first clock tick, the write address is on wrAdd, and the data to be written is on wrData, wrEOB, wrValid, wrTxId, and wrIncAdd must also be driven to the required values in this clock tick. The signals must hold the same value until wrDtAck is received. This allows for the address and data to be multiplexed onto the same mBus. The signal values may only be changed when wrDtAck is asserted, as illustrated.

A clock cycle after being received into the interface, the address is clocked out on mBusWrData. The data is then clocked out on mBusWrData in the next clock cycle, and wrDtAck is asserted. wrIncAdd and wrEOB are used to generate the mBusWrPhase signal. WrInfo contains the Source and Transaction ID while the address is on mBusWrData, and the bit valid field when there is data on mBusWrData.

wrAckReq must be driven at least in the same clock tick as wrEOB (but can be continuously driven), because the MSB of mBusWrInfo is set to wrAckReq at the End Of Burst phase, to request an acknowledge for the current transaction MBusWriteSel[X] is generated by address decoding, and is driven high for the entire write cycle.

Write Cycle with STROBE Signal

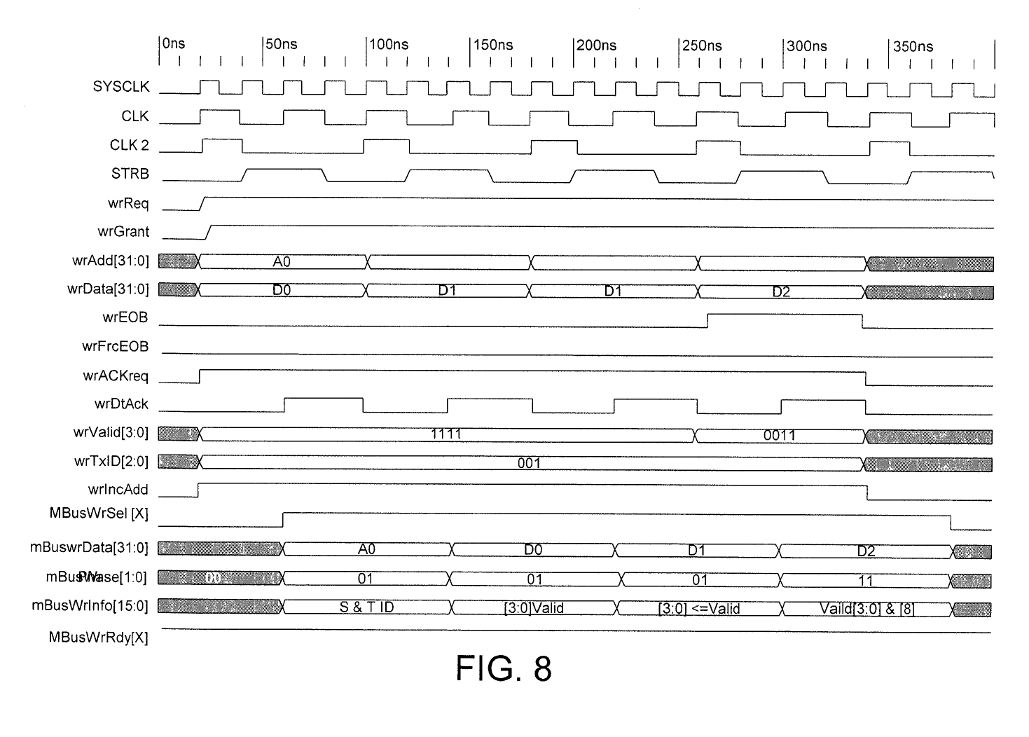

FIG. 8 shows a normal write transaction, where the interface and core run at the system clock frequency CLK. The mBus interface is clocking out to a slower clock, in this case CLK2 at half the system clock frequency. As is explained in the copending application, a strobe signal (STRBE) is used to control what edge of CLK is used for this data transfer.

To prevent the core from writing data faster than CLK2 can take it, wrDtAck is only asserted when STRBE is “high”, and is deasserted after one CLK period. The core should not change data on the bus while wrDtAck is de-asserted. This ensures smooth transfer of data between the two clock domains.

Write Acknowledge Timing

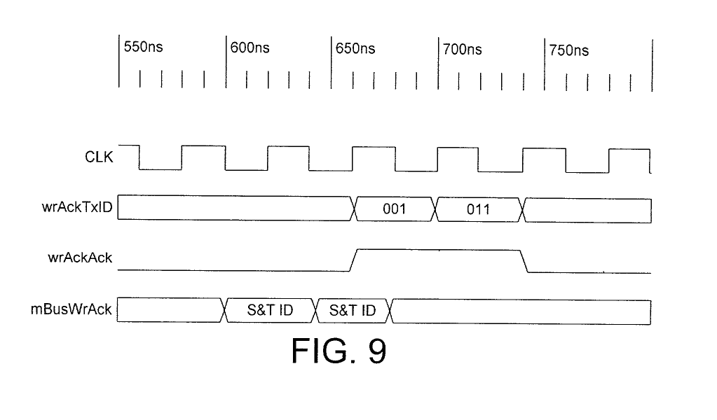

FIG. 9 illustrates the timing of the write acknowledgement (Write Ack). The source and transaction IDs are returned on the mBusWrAck bus. If the source ID is received matches the source ID of the core, then, a clock cycle later, the transaction ID is passed on to the core through the interface wrAckAck pulses high at the same time. If the source IDs do not match, then the mBusWrAck is ignored. A zero on the bus signifies no current acknowledgement.

Write that exceeds Max Burst Length

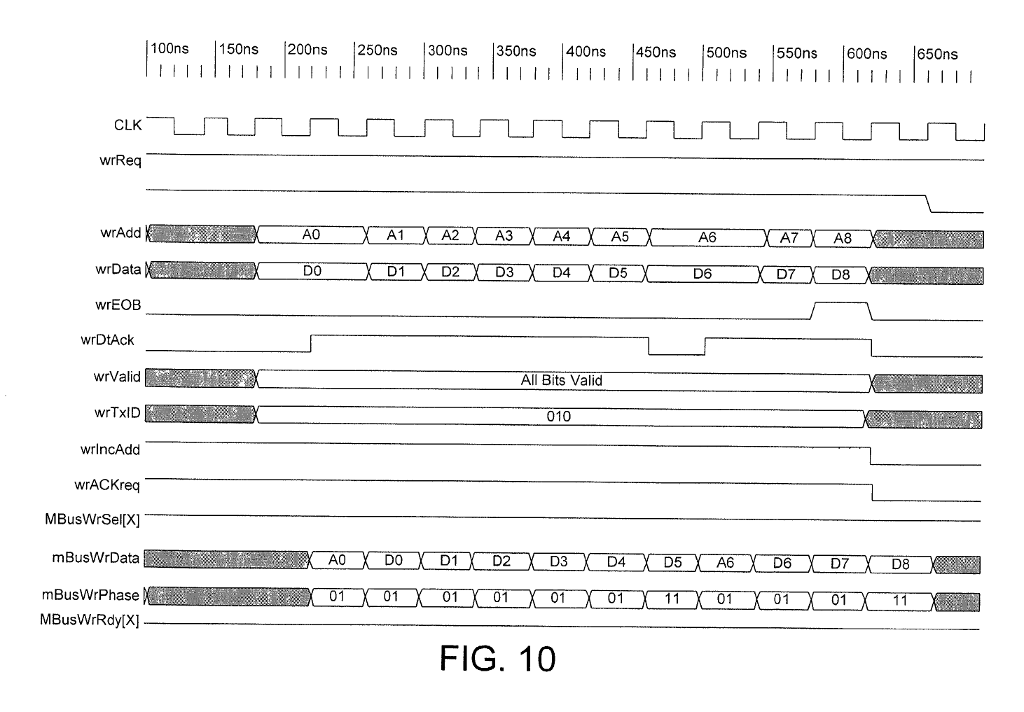

FIG. 10 illustrates what happens when a write is attempted that is greater than the maximum burst size supported by the system. If no wrEOB is received when the number of bytes written is exactly equal to the max burst size of the system, then the current write transaction is broken up into smaller transactions on the mBus. At maximum burst size, wrDtAck is deasserted, and mBusWrPhase is set to EOB. Another write transaction then begins immediately, as shown (A6 and D6 held on the bus for two cycles. A6 is clocked out on mBusWrData). This transaction continues until the wrEOB is received, or until the max burst size of the system is reached again.

Interrupted Write (Rdy Deasserted)

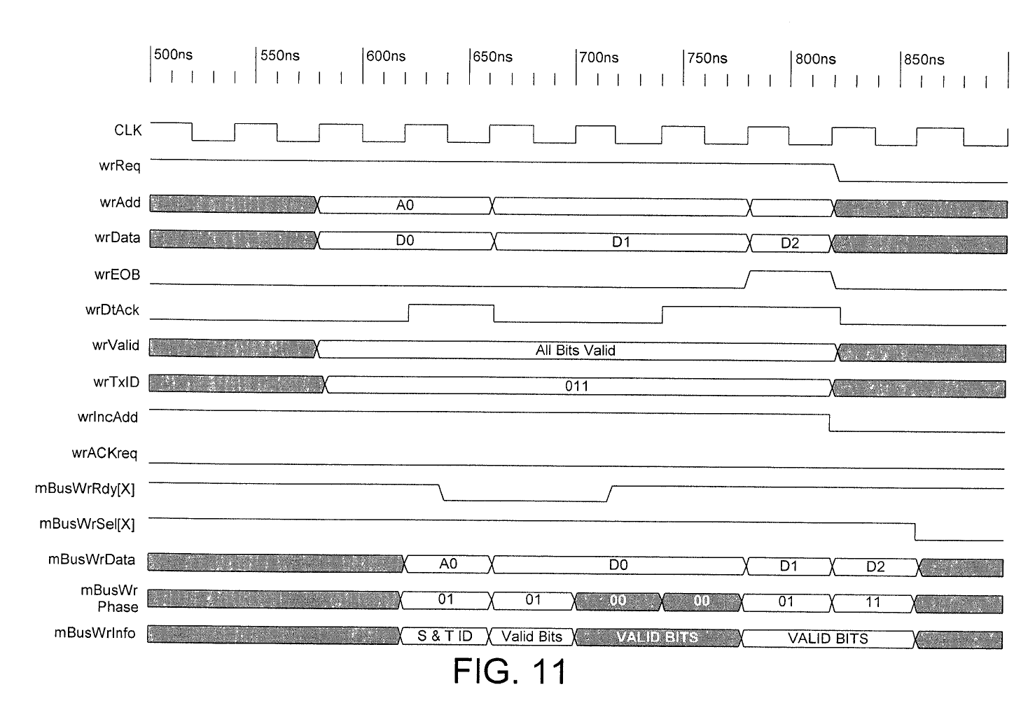

In FIG. 11, mBusWrRdy[X] is deasserted during a write. As soon as this is seen on the interface, wrDtAck is deasserted. This means that all signals on the core side of the interface should be held, and should not be changed until wrDtAck is asserted again.

In the next clock cycle, mBusWrPhase is set to NULL or IDLE irregardless. MBusWrData and other mBus signals should not be sampled while mBusWrPhase is NULL.

When mBusWrRdy[X] is reasserted, the write continues on from where it left off. A wrDtAck is generated, and the write continues as normal. It should be noted that there is one more clock cycle of data clocked out of the interface after mBusWrRdy[X] goes low. This is due to the delay in the interface in clocking in the mBusWrRdy[X] signal.

The write cycle can also be stalled by deasserting wrReq without first asserting wrEOB. In this case, the data on wrData is clocked out of the interface with an mBusWrPhase of IDLE, ensuring that this data is ignored.

Read Cycle

(a) Read Command

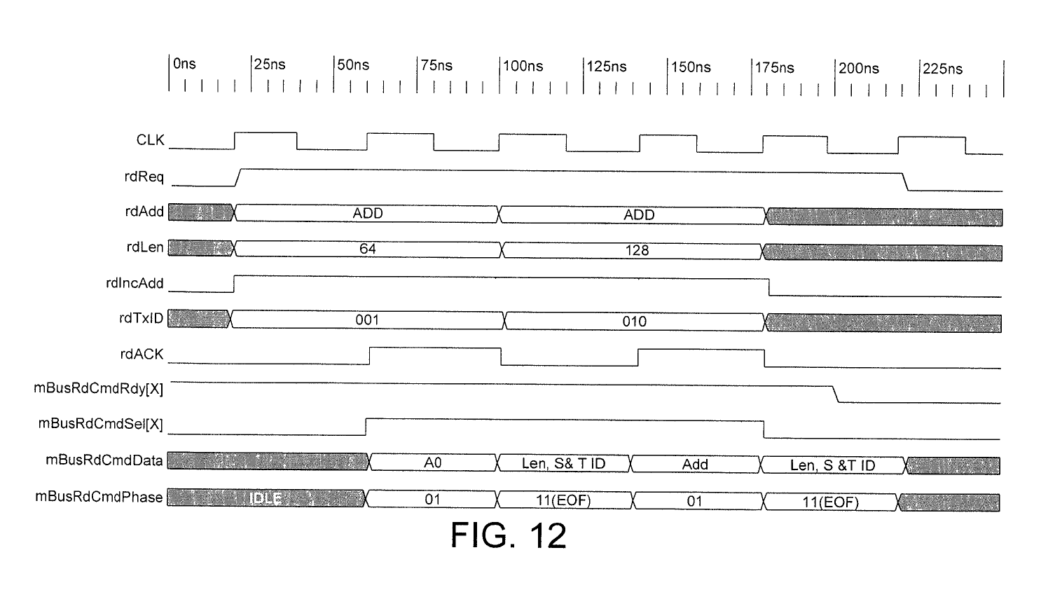

FIG. 12 shows a Read Command cycle mBusRdCmdRdy[X] (the bit corresponding to the correct target) must be high for the transaction to start rdReq must also be high, but needs only to remain high for the first clock cycle. Also in this clock tick, rdAdd, rdLen, rdIncAdd and rdTxId must be driven to the required values. These signals are held until a rdAck is received back from the interface, after which they may be changed. MBusRdCmdRdy[X] should be held high for the duration of the read command. If it is deasserted, the read command will stall, and will continue when mBusRdCmdRdy[X] is asserted again. The timing of this is the same as that for a stalled write command (See section Interrupted Write (Rdy Deasserted)).

In the next clock tick, the address on rdAdd is clocked out on mBusRdCmdData, and the rdIncAdd signal is translated into the mBusRdCmdPhase signal. During the second clock tick of the read command, rdLen, the source ID and rdTxId are clocked out on mBusRdCmdData, and mBusRdCmdPhase indicates End of Burst mBusRdCmdSel[X] is driven high for the duration of the read command cycle. FIG. 12 shows two read commands, one directly after the other.

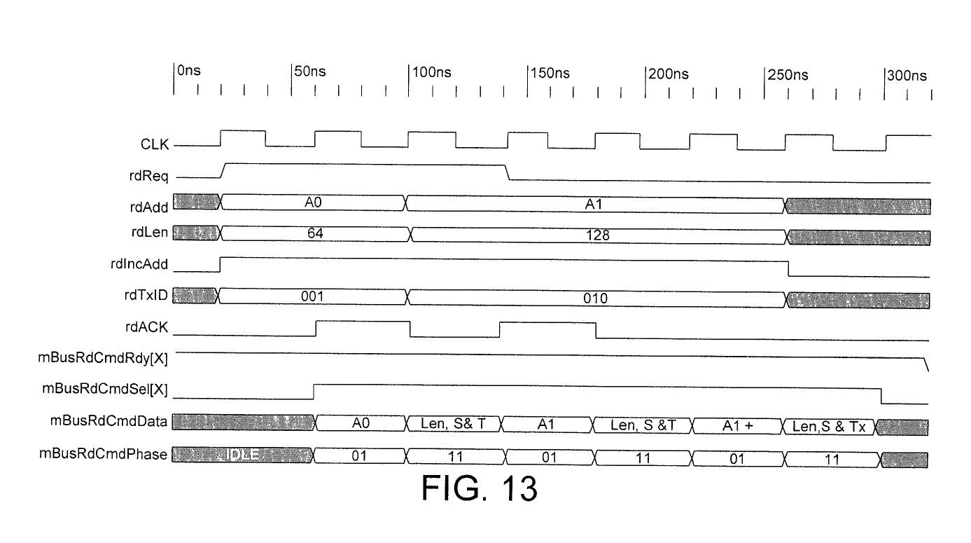

FIG. 13 illustrates an extended read command. The system has a defined maximum burst size, and requests for reads bigger that this must be broken up into smaller reads

In the above example, max burst size is set to 64, and so a read request of 128 translates into two read requests of 64 bytes each. A rdAck is received, but any subsequent read requests by the core will be stalled, no rdAck will be generated, and so subsequent requests will be held on the bus until the extended read request has finished.

(c) Read Cycle

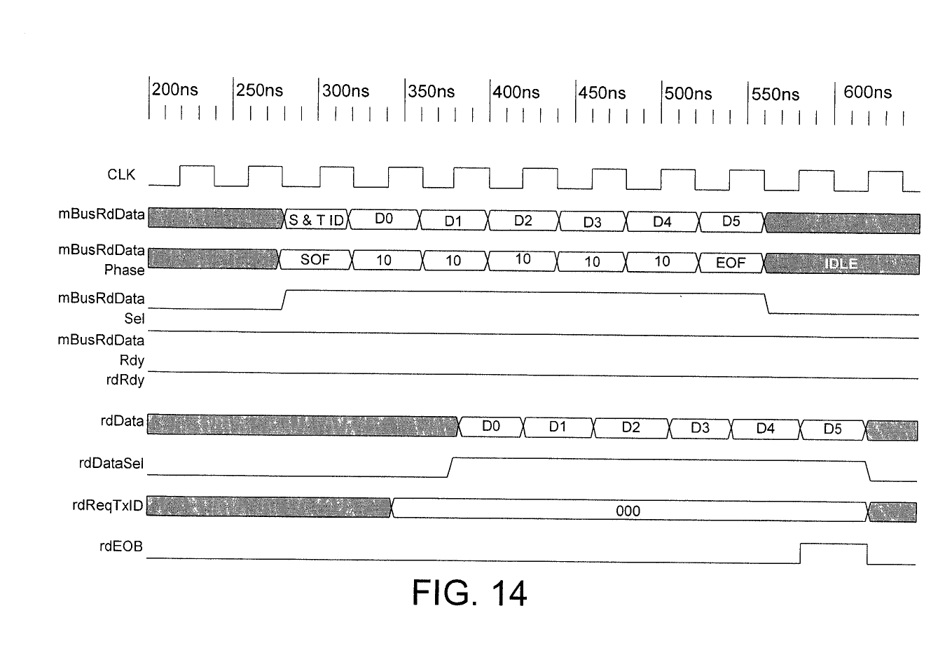

FIG. 14 shows a Read cycle. For a read cycle to begin, mBusRdDataSel and rdRdy must be asserted. In the first phase of the read, mBusRdData contains the Source and Transaction Id, and mBusRdDataPhase contains the Start of Frame flag. A clock tick later, the rdReqTxId is recovered from mBusRdData and clocked out on the other side of the interface. At the same time, mBusRdDataSel is translated into rdDataSel and clocked out. During the second phase of the read, data appears on mBusRdData, and is clocked out on rdData a clock tick later. At the end of the read, mBusRdDataPhase contains the end of burst flag. This is extracted and clocked out on rdEOB at the same time as the last data word appears on rdData.

(d) Read Cycle with SAMPLE Signal

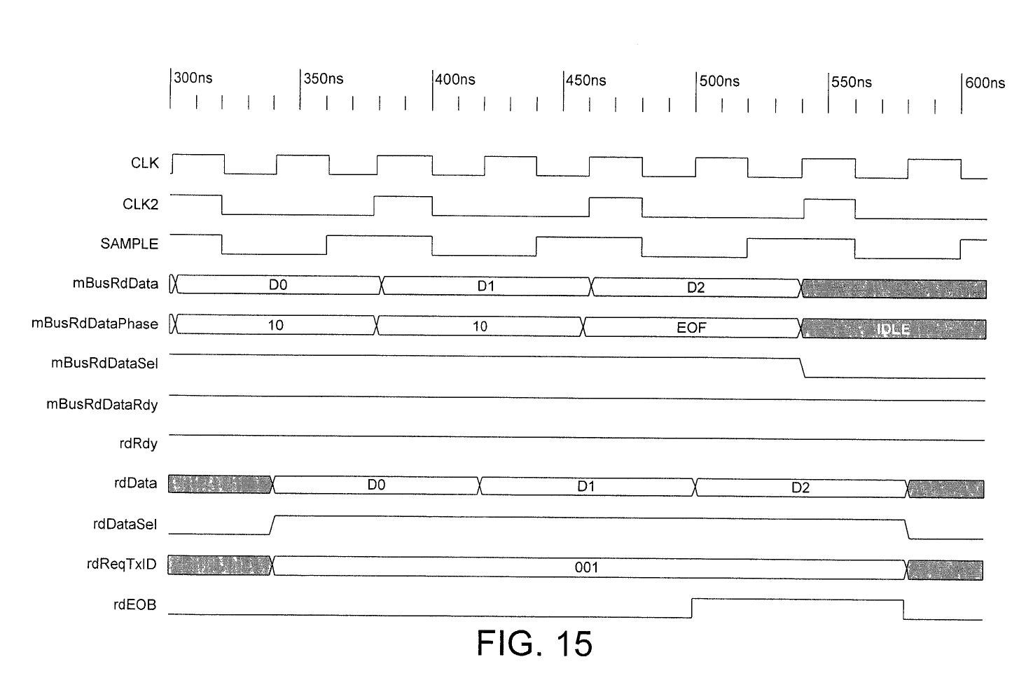

FIG. 15 shows a normal read cycle, where the mBus interface and the core run at CLK, and the read data is being transferred from a slower clock domain, clocked by CLK2. The SAMPLE signal is used to ensure that the interface reads in the data at the correct frequency. The interface only samples the incoming data when SAMPLE is high.

(e) Paused Read Cycle

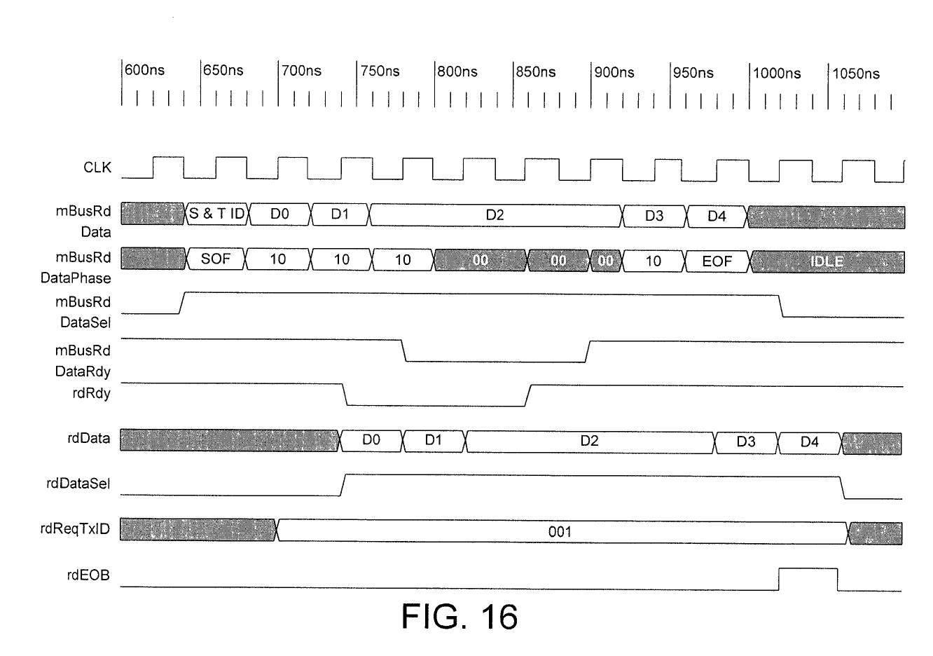

FIG. 16 illustrates what happens when rdRdy de-asserts in the middle of a read cycle mBusRdRdy de-asserts one clock tick after rdRdy. This has the effect of pausing the read cycle, as shown in FIG. 16. While mBusRdRdy is de-asserted, no new data is passed into the interface, and the mBusRdDataPhase contains the Null or IDLE flag. When rdRdy is re-asserted, the transaction continues as normally. The read cycle will also stall if mBusRdDataSel is de-asserted before the reception of an EOF phase flag. In this case, rdDataSel will also deassert, and so any data changes on MBusRdData will not be seen by the core.

rBus Interface Timing

The register bus is used to read from and write to registers in a target. The rBus bridge is the initiator of the rBus and the cores or core wrappers are the targets of the rBus. Multiple cores can hang off the rBus but the rBus Bridge dictates the speed of the rBus. Therefore all targets must communicate with the bridge via the rBus using this specified speed. The rBus is a half duplex implementation of a bus. This means that some of the signals are shared for reads and writes.

The rBus interfaces to mBus via the bridge. The bridge translates mBus signals to corresponding rBus signals in the write path and vice-versa in the read back path.

There is no need for the strobe and sample signals, mentioned in the mBus description, on the rBus because the speed of the initiator will normally be slower than the speed of any of its connected targets. If one of the targets should happen to run at a slower speed than the initiator then the core wrapper of the target would have to correct the speed of the target at its rBus interface such that it communicates with the bridge at the same speed or faster using the strobe and sample signals.

Strobe and sample signals will be needed at the rBus Interface of the targets if they run at a different speed to the initiator.

rBusWrite Cycle

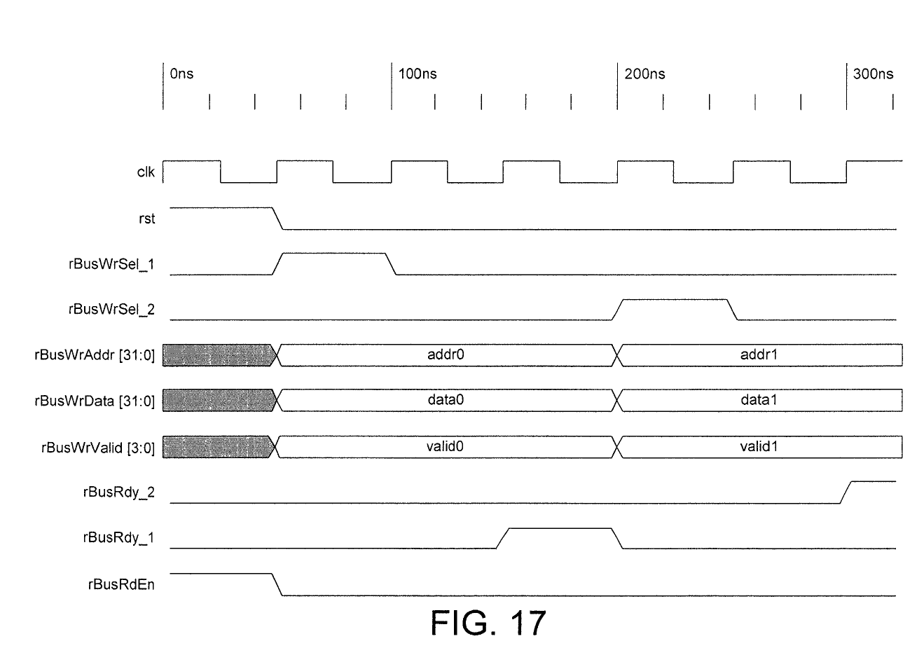

In FIG. 17, rBusRdEn is low, indicating that the transaction is a write to a register location. The bridge initiates a transaction on the rBus by first selecting the target that it wants to write to. At the same time the target is selected the address of the register in the target, the data to write to that register and the valid signals are all placed on the bus.

The target is only selected for one clock cycle but the address, data and valids remain on the bus until a new target is selected and/or new data is ready to go on the bus.

New data cannot be sent out on the bus until rBusRdy is received back from the same target. This signal indicates that the data has been written to the correct register location and the target is ready to accept a new command.

rBus Read Cycle.

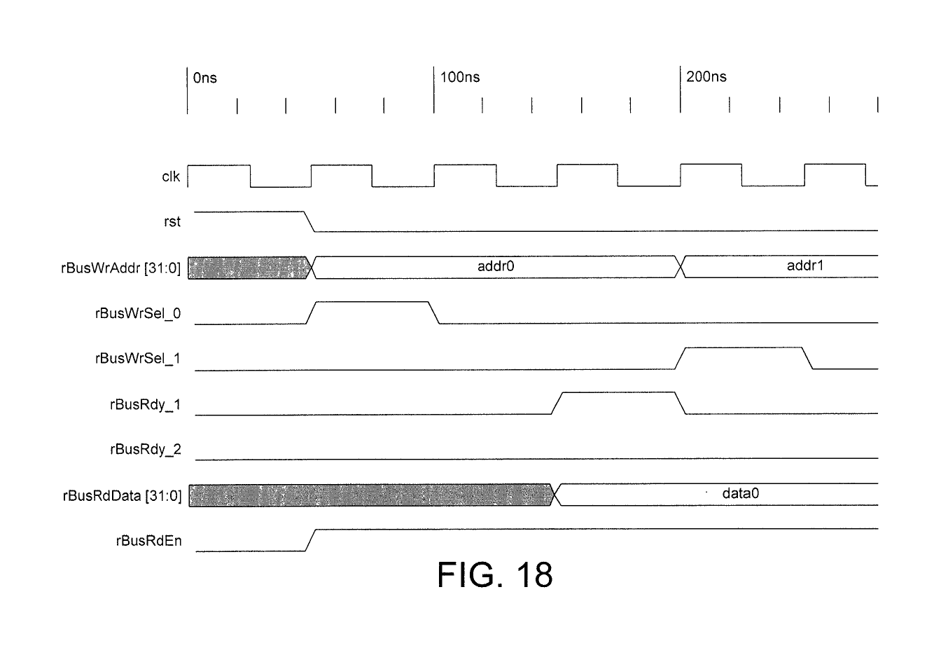

In FIG. 18, rBusRdEn is high, indicating a read transaction from a register location.

The initiator requests a read from a specific register location in a target using the write address signal. The initiator first selects the target it wishes to read and at the same time places the address of the register it wants to read on the write address bus, rBusWrAddr. The initiator can not request to read any other registers in any of the connected targets until it has received back the data it requested.

When the data is sent from the target back to the initiator a ready signal is also asserted to indicate to the initiator that the data on the bus is correct.

The ready signal for a particular target, rBusRdy_X, also implies that the target is ready to accept new commands and has finished the last transaction.

Once rBusRdy_X is received by the initiator a new request can be sent out on the bus.

1. An application specific integrated circuit comprising
a memory controller for storing and retrieving addressed data messages in memory,
a multiplicity of operational cores and at least one arbiter for controlling the order of passage of transactions through said arbiter, and
a memory bus, having a multiplicity of signal lines, for coupling transactions between each core and said memory controller by way of said at least one arbiter,
wherein said cores initiate writing transactions and reading transactions by means of which said data messages are stored in and retrieved from said memory by way of said memory bus and said arbiter,
wherein a writing transaction comprises placing on respective lines of said bus a write request and an identifier of a source of the writing transaction, and
wherein said writing transaction further comprises returning to said source an acknowledgement signal including said identifier.

2. A circuit according to claim 1 wherein said writing transaction includes placing on said bus an identifier of said writing transaction and said acknowledgement includes said identifier of said writing transaction.

3. A circuit according to claim 1 wherein a writing transaction includes a request signal indicating whether said acknowledgement is required.

4. A circuit according to claim 1 wherein a reading transaction comprises placing on respective lines of said bus a read request and an identifier of an initiator of the request and further comprises sending with the read data an acknowledgement including the identifier of the initiator.

5. An application specific integrated circuit comprising
a memory controller for storing and retrieving addressed data messages in memory,
a multiplicity of operational cores and at least one arbiter for controlling the order of passage of transactions through said arbiter,
a memory bus, having a multiplicity of signal lines, for coupling transactions between each core and said memory controller by way of said at least one arbiter, and
at least one data processor coupled by way of said bus and said arbiter to said memory controller
wherein said cores and said processor initiate writing transactions and reading transactions by means of which said data messages can be stored in said memory by way of said memory bus and said arbiter,
wherein a writing transaction comprises placing on respective lines of said bus a write request and identifiers of the source of the transaction and of the writing transaction, and
wherein said writing transaction further comprises returning to said source an acknowledgement signal including said identifiers.

6. A circuit according to claim 5 wherein a reading transaction comprises placing on respective lines of said bus a read request and identifiers of an initiator of the request and the read transaction and further comprises sending with the read data an acknowledgement including the identifiers of the initiator and the read transaction.

7. A circuit according to claim 5 and further comprising a register bus extending to and from said cores and said processor is coupled to provide register transactions on said register bus.

8. A circuit according to claim 7 and including a bridge coupled to a section of said memory bus and to said register bus and wherein said processor sends register transactions to and receives transaction from said bridge, which translates said register transactions between the memory bus and the register bus.

9. An application specific integrated circuit comprising
a memory controller for storing and retrieving addressed data messages in memory,
a multiplicity of operational cores,
a memory bus, having a multiplicity of signal lines, for coupling transactions between each core and said memory controller,
wherein said cores initiate writing transactions and reading transactions by means of which said data messages can be stored in and retrieved from said memory by way of said memory bus,
wherein each transaction comprises a request for the transaction, an identifier of the source of the transaction and an identifier of said transaction.

10. A circuit according to claim 9 wherein at least some transactions include a request for an acknowledgement and further include returning to said source an acknowledgement signal including the identifiers of the source and the writing transaction.

11. A circuit according to claim 9 wherein each identifier comprises a multibit field

12. A circuit according to claim 9 wherein each of said cores has a unique source identifier.

13. A circuit according to claim 9 wherein for each core the identifer of a transaction comprises a number in a respective cyclic sequence.

14. An application specific integrated circuit comprising
a memory controller for storing and retrieving addressed data messages in memory, and
a memory bus, having a multiplicity of signal lines, for coupling transactions between each core and said memory controller, and wherein
(I) said cores initiate writing transactions and reading transactions by means of which said data messages can be stored in and retrieved from said memory by way of said memory bus,
(II) each transaction comprises a write request, an identifier of a source of the transaction and an identifier of the writing transaction,
(III) a writing transaction further comprises returning to said source an acknowledgement signal including said identifier, and
(IV) a reading transaction comprises a read request and identifiers of at least an initiator of the request and the respective reading transaction and further comprises an acknowledgement including the identifiers of the initiator and the respective read transaction.

15. A circuit according to claim 14 wherein each identifier comprises a multibit field.

16. A circuit according to claim 14 wherein each of said cores has a unique source identifier.

17. A circuit according to claim 14 wherein for each core the identifier of a transaction comprises a number in a respective cyclic sequence.

18. An application specific integrated circuit comprising
(a) a memory controller for storing and retrieving addressed data messages in memory, and
(b) a memory bus, having a multiplicity of signal lines, for coupling transactions between each core and said memory controller, and wherein
(I) said cores initiate writing transactions and reading transactions by means of which said data messages can be stored in and retrieved from said memory by way of said memory bus,
(II) a writing transaction comprises a write request, an identifier of a source of the transaction and an identifier of the writing transaction,
(III) a writing transaction further comprises returning to said source an acknowledgement signal including said identifiers,
(IV) a reading transaction comprises a read request and identifiers of at least an initiator of the request and the respective reading transaction and further comprises an acknowledgement including the identifiers of the initiator and the respective read transaction.
(V) each identifier comprises a multibit field;
(VI) each of said cores has a unique source identifier, and
(VII) for each core the identifer of a transaction comprises a number in a respective cyclic sequence.
